(19) United States
(12) Patent Application Publication
(10) Pub. No.: US 2021/0295770 A1
(43) Pub. Date: Sep. 23, 2021

(54) DISPLAY DEVICE

(71) Applicant: LG ELECTRONICS INC., Seoul (KR)

(72) Inventors: Youngho CHUN, Seoul (KR); Byungwoo Ryu, Seoul (KR)

(73) Assignee: LG ELECTRONICS INC., Seoul (KR)

(21) Appl. No.: 16/938,874

(22) Filed: Jul. 24, 2020

(30) Foreign Application Priority Data
Mar. 19, 2020 (KR) 10-2020-0033587

(51) Int. Cl. G09G 3/3208

(52) U.S. Cl. CPC G09G 3/3208; G09G 2370/12; G09G 2320/0257

(57) ABSTRACT

The present disclosure relates to a display device for reducing an input-lag time, capable of detecting an input frequency of a video signal received through an external input interface and adjusting an output frequency of the display panel according to the detected input frequency.

### CROSS-REFERENCE TO RELATED APPLICATIONS

Pursuant to 35 U.S.C. § 119(a), this application claims the benefit of earlier filing date and right of priority to Korean Patent Application No. 10-2020-0033587, filed on Mar. 19, 2020, the contents of which are hereby incorporated by reference herein in its entirety.

### BACKGROUND OF THE INVENTION

### 1. Field of the Invention

The present disclosure relates to a display device, and more particularly, to an organic light emitting diode display device.

### 2. Discussion of the Related Art

Recently, various types of display devices have been provided. Among them, an Organic Light Emitting Diode display device (hereinafter referred to as “OLED display device”) is frequently used.

The OLED display device is a display device using organic light emitting elements. Since the organic light emitting elements are self-light-emitting elements, the OLED display device has advantages of being fabricated to have lower power consumption and be thinner than a liquid crystal display device requiring a backlight. In addition, the OLED display device has advantages such as a wide viewing angle and a fast response speed.

Input-Lag refers to an input delay phenomenon in which the response speed of a video output according to a signal input through an input device such as a mouse is slowed down.

The display panel of a conventional OLED display device has processed only a video signal having a predetermined input frequency.

Accordingly, when a video signal having a frequency other than the predetermined input frequency is input, a data region of the video signal is input long, thus input time being inevitably increased.

For example, when the predetermined frequency is 120 Hz (120 image frames are input per second) and the input frequency of the video signal is 60 Hz (60 image frames are input per second), a delay may occur in the display device until 60 image frames are additionally input.

Accordingly, there is a problem in that the input-lag time is increased and a response speed of video output is reduced.

### SUMMARY OF THE INVENTION

An object of the present disclosure is to provide a display device capable of reducing an input-lag time of a display device.

An object of the present disclosure is to provide a display device capable of changing an output frequency of a display panel according to an input frequency of a video signal.

A display device according to an embodiment of the present disclosure may detect an input frequency of a video signal received through an external input interface, and adjust an output frequency of the display panel according to the detected input frequency.

The display device may change an output frequency of the display panel from the first output frequency to the second output frequency when the input frequency is detected at a second output frequency in a state in which the output frequency of the display panel is set to the first output frequency.

The control unit may change a compensation sequence for afterimage compensation of the display panel according to the second output frequency which is changed.

According to an embodiment of the present disclosure, it is possible to improve a response speed of video output according to a decrease in an input-lag time.

Accordingly, a user may feel the delay of video output relatively less, and the immersion degree of video viewing may be improved.

### BRIEF DESCRIPTION OF THE DRAWINGS

FIG. 1 is a diagram illustrating a display device according to an embodiment of the present disclosure.

FIG. 2 is a block diagram showing a configuration of the display device of FIG. 1.

FIG. 3 is an example of an internal block diagram of the control unit of FIG. 2.

FIG. 4A is a diagram illustrating a control method for a remote control device of FIG. 2.

FIG. 4B is an internal block diagram of the remote control device of FIG. 2.

FIG. 5 is an internal block diagram of the display unit of FIG. 2.

FIGS. 6A to 6B are views referred to for description of the organic light emitting panel of FIG. 5.

FIG. 7 is a diagram for describing a process of outputting a video by adjusting an output frequency according to an input frequency of a video signal.

FIG. 8 is a flowchart for describing an operation method of a display device according to an embodiment of the present disclosure.

FIGS. 9 and 10 are diagrams shoving comparison with the prior art to show that input-lag is improved according to the present disclosure.

FIG. 11 is a diagram for describing a table in which input-lag times of the prior art and the present disclosure are compared with each other.

FIG. 12 is a diagram showing an example of changing a compensation sequence for afterimage compensation when an output frequency of a display panel is changed according to an input frequency according to an embodiment of the present disclosure.

### DETAILED DESCRIPTION OF THE PREFERRED EMBODIMENTS

Hereinafter, the present disclosure will be described in more detail with reference to the drawings.

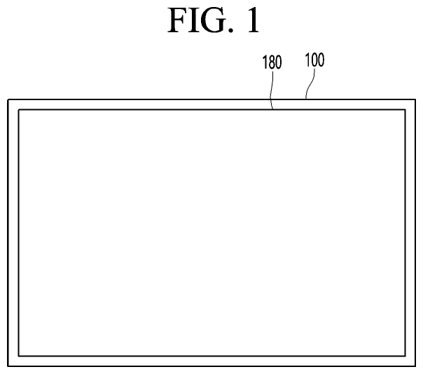

FIG. 1 is a diagram illustrating a display device according to an embodiment of the present disclosure.

Referring to the drawings, a display device 100 may include a display unit 180.

Meanwhile, the display unit 180 may be implemented with any one of various panels. For example, the display unit 180 may be any one of a liquid crystal display panel (LCD panel), an organic light emitting diode panel (OLED panel), and an inorganic light emitting diode panel (LED panel).

In the present disclosure, it is assumed that the display unit 180 includes an organic light emitting diode panel (OLED panel). It should be noted that this is only exemplary, and the display unit 180 may include a panel other than an organic light emitting diode panel (OLED panel).

Meanwhile, the display device 100 of FIG. 1 may be a monitor, a TV, a tablet PC, or a mobile terminal.

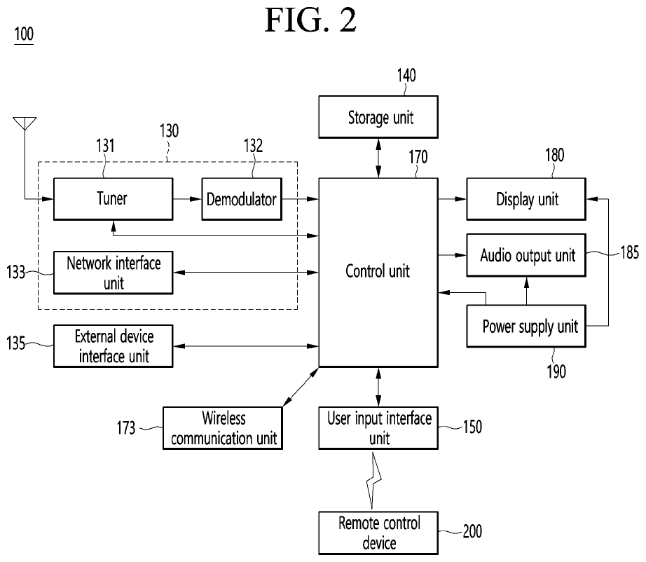

FIG. 2 is a block diagram showing a configuration of the display device of FIG. 1.

Referring to FIG. 2, the display device 100 may include a broadcast receiving unit 130, an external device interface unit 135, a storage unit 140, a user input interface unit 150, a control unit 170, and a wireless communication unit 173, a display unit 180, an audio output unit 185, and a power supply unit 190.

The broadcast receiving unit 130 may include a tuner 131, a demodulator 132, and a network interface unit 133.

The tuner 131 may select a specific broadcast channel according to a channel selection command. The tuner 131 may receive a broadcast signal for the selected specific broadcast channel.

The demodulator 132 may separate the received broadcast signal into a video signal, an audio signal, and a data signal related to a broadcast program, and restore the separated video signal, audio signal, and data signal to a format capable of being output.

The network interface unit 133 may provide an interface for connecting the display device 100 to a wired/wireless network including an Internet network. The network interface unit 133 may transmit or receive data to or from other users or other electronic devices through a connected network or another network linked to the connected network.

The network interface unit 133 may access a predetermined web page through the connected network or the other network linked to the connected network. That is, it is possible to access a predetermined web page through a network, and transmit or receive data to or from a corresponding server.

In addition, the network interface unit 133 may receive content or data provided by a content provider or a network operator. That is, the network interface unit 133 may receive content such as a movie, advertisement, game, VOD, broadcast signal, and related information provided by a content provider or a network provider through a network.

In addition, the network interface unit 133 may receive update information and update files of firmware provided by the network operator, and may transmit data to an Internet or content provider or a network operator.

The network interface unit 133 may select and receive a desired application from among applications that are open to the public through a network.

The external device interface unit 135 may receive an application or a list of applications in an external device adjacent thereto, and transmit the same to the control unit 170 or the storage unit 140.

The external device interface unit 135 may provide a connection path between the display device 100 and the external device. The external device interface unit 135 may receive one or more of video and audio output from an external device wirelessly or wired to the display device 100 and transmit the same to the control unit 170. The external device interface unit 135 may include a plurality of external input terminals. The plurality of external input terminals may include an RGB terminal, one or more High Definition Multimedia Interface (HDMI) terminals, and a component terminal.

The video signal of the external device input through the external device interface unit 135 may be output through the display unit 180. The audio signal of the external device input through the external device interface unit 135 may be output through the audio output unit 185.

The external device connectable to the external device interface unit 135 may be any one of a set-top box, a Blu-ray player, a DVD player, a game machine, a sound bar, a smartphone, a PC, a USB memory, and a home theater, but this is only an example.

In addition, a part of content data stored in the display device 100 may be transmitted to a selected user among a selected user or a selected electronic device among other users or other electronic devices registered in advance in the display device 100.

The storage unit 140 may store programs for signal processing and control of the control unit 170, and may store video, audio, or data signals, which have been subjected to signal-processed.

In addition, the storage unit 140 may perform a function for temporarily storing video, audio, or data signals input from an external device interface unit 135 or the network interface unit 133, and store information on a predetermined video through a channel storage function.

The storage unit 140 may store an application or a list of applications input from the external device interface unit 135 or the network interface unit 133.

The display device 100 may play back a content file (a moving image file, a still image file, a music file, a document file, an application file, or the like) stored in the storage unit 140 and provide the same to the user.

The user input interface unit 150 may transmit a signal input by the user to the control unit 170 or a signal from the control unit 170 to the user. For example, the user input interface unit 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the control unit 170 to the remote control device 200.

In addition, the user input interface unit 150 may transmit a control signal input from a local key (not shown) such as a power key, a channel key, a volume key, and a setting value to the control unit 170.

The video signal image-processed by the control unit 170 may be input to the display unit 180 and displayed with video corresponding to a corresponding video signal. Also, the video signal image-processed by the control unit 170 may be input to an external output device through the external device interface unit 135.

The audio signal processed by the control unit 170 may be output to the audio output unit 185. Also, the audio signal processed by the control unit 170 may be input to the external output device through the external device interface unit 135.

In addition, the control unit 170 may control the overall operation of the display device 100.

In addition, the control unit 170 may control the display device 100 by a user command input through the user input interface unit 150 or an internal program and connect to a network to download an application a list of applications or applications desired by the user to the display device 100.

The control unit 170 may allow the channel information or the like selected by the user to be output through the display unit 180 or the audio output unit 185 along with the processed video or audio signal.

In addition, the control unit 170 may output a video signal or an audio signal through the display unit 180 or the audio output unit 185, according to a command for playing back a video of an external device through the user input interface unit 150, the video signal or the audio signal being input from an external device, for example, a camera or a camcorder, through the external device interface unit 135.

Meanwhile, the control unit 170 may allow the display unit 180 to display a video, for example, allow a broadcast video which is input through the tuner 131 or an external input video which is input through the external device interface unit 135, a video which is input through the network interface unit or a video which is stored in the storage unit 140 to be displayed on the display unit 180. In this case, the video displayed on the display unit 180 may be a still image or a moving image, and may be a 2D image or a 3D image.

In addition, the control unit 170 may allow content stored in the display device 100, received broadcast content, or external input content input from the outside to be played back, and the content may have various forms such as a broadcast video, an external input video, an audio file, still images, accessed web screens, and document files.

The wireless communication unit 173 may communicate with an external device through wired or wireless communication. The wireless communication unit 173 may perform short range communication with an external device. To this end, the wireless communication unit 173 may support short range communication using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication unit 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, the another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication unit 173 may detect (or recognize) a wearable device capable of communication around the display device 100. Furthermore, when the detected wearable device is an authenticated device to communicate with the display device 100 according to the present disclosure, the control unit 170 may transmit at least a portion of data processed by the display device 100 to the wearable device through the wireless communication unit 173. Therefore, a user of the wearable device may use data processed by the display device 100 through the wearable device.

The display unit 180 may convert a video signals, data signal, or OSD signal processed by the control unit 170, or a video signal or data signal received from the external device interface unit 135 into R, G, and B signals, and generate drive signals.

Meanwhile, the display device 100 illustrated in FIG. 2 is only an embodiment of the present disclosure, and therefore, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 2, the display device 100 may receive a video through the network interface unit 133 or the external device interface unit 135 without a tuner 131 and a demodulator 132 and play back the same.

For example, the display device 100 may be divided into an image processing device, such as a set-top box, for receiving broadcast signals or content according to various network services, and a content playback device that plays back content input from the image processing device.

In this case, an operation method of the display device according to an embodiment of the present disclosure will be described below may be implemented by not only the display device 100 as described with reference to FIG. 2 and but also one of an image processing device such as the separated set-top box and a content playback device including the display unit 180 the audio output unit 185.

The audio output unit 185 may receive a signal audio-processed by the control unit 170 and output the same with audio.

The power supply unit 190 may supply corresponding power to the display device 100. Particularly, power may be supplied to the control unit 170 that may be implemented in the form of a system on chip (SOC), the display unit 180 for video display, and the audio output unit 185 for audio output.

Specifically, the power supply unit 190 may include a converter that converts AC power into DC power, and a dc/dc converter that converts a level of DC power.

The remote control device 200 may transmit a user input to the user input interface unit 150. To this end, the remote control device 200 may use Bluetooth, Radio Frequency (RF) communication, Infrared (IR) communication, Ultra Wideband (UWB), ZigBee, or the like. In addition, the remote control device 200 may receive a video, audio, or data signal or the like output from the user input interface unit 150, and display or output the same through the remote control device 200 by video or audio.

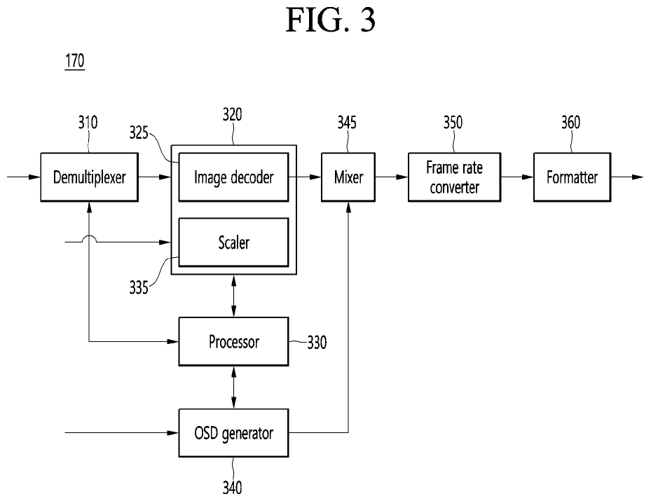

FIG. 3 is an example of an internal block diagram of the controller of FIG. 2.

Referring to the drawings, the control unit 170 according to an embodiment of the present disclosure may include a demultiplexer 310, an image processing unit 320, a processor 330, an OSD generator 340, a mixer 345, a frame rate converter 350, and a formatter 360. In addition, an audio processing unit (not shown) and a data processing unit (not shown) may be further included.

The demultiplexer 310 may demultiplex input stream. For example, when MPEG-2 TS is input, the demultiplexer 310 may demultiplex the MPEG-2 TS to separate the MPEG-2 TS into video, audio, and data signals. Here, the stream signal input to the demultiplexer 310 may be a stream signal output from the tuner 131, the demodulator 132 or the external device interface unit 135.

The image processing unit 320 may perform image processing on the demultiplexed video signal. To this end, the image processing unit 320 may include an image decoder 325 and a scaler 335.

The image decoder 325 may decode the demultiplexed video signal, and the scaler 335 may scale a resolution of the decoded video signal to be output through the display unit 180.

The video decoder 325 may be provided with decoders of various standards. For example, an MPEG-2, H.264 decoder, a 3D video decoder for color images and depth images, and a decoder for multi-view images may be provided.

The processor 330 may control the overall operation of the display device 100 or of the control unit 170. For example, the processor 330 may control the tuner 131 to select (tune) an RF broadcast corresponding to a channel selected by a user or a pre-stored channel.

In addition, the processor 330 may control the display device 100 by a user command input through the user input interface unit 150 or an internal program.

In addition, the processor 330 may perform data transmission control with the network interface unit 135 or the external device interface unit 135.

In addition, the processor 330 may control operations of the demultiplexer 310, the image processing unit 320, and the OSD generator 340 in the control unit 170.

The OSD generator 340 may generate an OSD signal according to a user input or by itself. For example, based on a user input signal, a signal for displaying various information on a screen of the display unit 180 as a graphic or text may be generated. The generated OSD signal may include various data such as a user interface screen, various menu screens, widgets, and icons of the display device 100. In addition, the generated OSD signal may include a 2D object or a 3D object.

In addition, the OSD generator 340 may generate a pointer that may be displayed on the display unit 180 based on a pointing signal input from the remote control device 200. In particular, such a pointer may be generated by the pointing signal processing unit, and the OSD generator 340 may include such a pointing signal processing unit (not shown). Of course, the pointing signal processing unit (not shown) may be provided separately, not be provided in the OSD generator 340

The mixer 345 may mix the OSD signal generated by the OSD generator 340 and the decoded video signal image-processed by the image processing unit 320. The mixed video signal may be provided to the frame rate converter 350.

The frame rate converter (FRC) 350 may convert a frame rate of an input video. On the other hand, the frame rate converter 350 may output the input video as it is, without a separate frame rate conversion.

On the other hand, the formatter 360 may change the format of the input video signal into a video signal to be displayed on the display and output the same.

The formatter 360 may change the format of the video signal. For example, it is possible to change the format of the 3D video signal to any one of various 3D formats such as a side by side format, a top/down format, a frame sequential format, an interlaced format, a checker box and the like.

Meanwhile, the audio processing unit (not shown) in the control unit 170 may perform audio processing of a demultiplexed audio signal. To this end, the audio processing unit (not shown) may include various decoders.

In addition, the audio processing unit (not shown) in the control unit 170 may process a base, treble, volume control, and the like.

The data processing unit (not shown) in the control unit 170 may perform data processing of the demultiplexed data signal. For example, when the demultiplexed data signal is an encoded data signal, the demultiplexed data signal may be decoded. The coded data signal may be electronic program guide information including broadcast information such as a start time and an end time of a broadcast program broadcast on each channel.

Meanwhile, a block diagram of the control unit 170 illustrated in FIG. 3 is a block diagram for an embodiment of the present disclosure. The components of the block diagram may be integrated, added, or omitted depending on the specification of the control unit 170 that is actually implemented.

In particular, the frame rate converter 350 and the formatter 360 may not be provided in the control unit 170, and may be separately provided or separately provided as a single module.

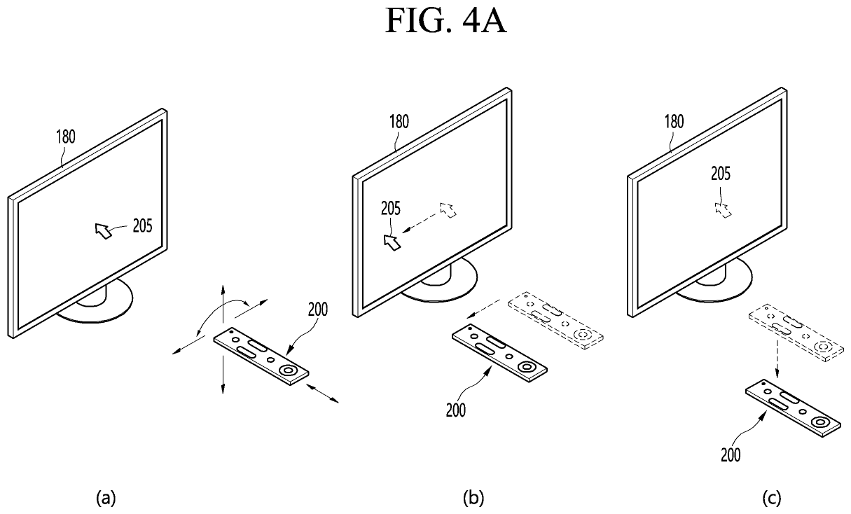

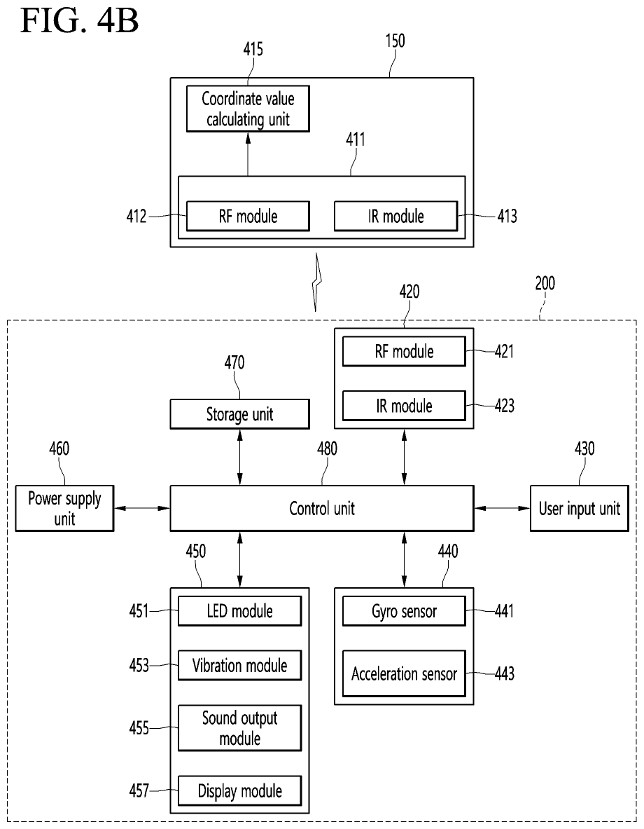

FIG. 4A is a diagram illustrating a control method for a remote control device of FIG. 2.

In (a) of FIG. 4A, it is illustrated that a pointer 205 corresponding to the remote control device 200 is displayed on the display unit 180.

The user may move or rotate the remote control device 200 up and down, left and right (FIG. 4A (b)), and forward and backward ((c) of FIG. 4A). The pointer 205 displayed on the display unit 180 of the display device may correspond to the movement of the remote control device 200. The remote control device 200 may be referred to as a spatial remote controller or a 3D pointing device, as the corresponding pointer 205 is moved and displayed according to the movement on a 3D space, as shown in the drawing.

In (b) of FIG. 4A, it is illustrated that that when the user moves the remote control device 200 to the left, the pointer 205 displayed on the display unit 180 of the display device moves to the left correspondingly.

Information on the movement of the remote control device 200 detected through a sensor of the remote control device 200 is transmitted to the display device. The display device may calculate the coordinates of the pointer 205 based on information on the movement of the remote control device 200. The display device may display the pointer 205 to correspond to the calculated coordinates.

In (c) of FIG. 4A, it is illustrated that a user moves the remote control device 200 away from the display unit 180 while pressing a specific button in the remote control device 200. Accordingly, a selected region in the display unit 180 corresponding to the pointer 205 may be zoomed in and displayed to be enlarged. Conversely, when the user moves the remote control device 200 close to the display unit 180, the selected region in the display unit 180 corresponding to the pointer 205 may be zoomed out and displayed to be reduced. On the other hand, when the remote control device 200 moves away from the display unit 180, the selected region may be zoomed out, and when the remote control device 200 moves close to the display unit 180, the selected region may be zoomed in.

Meanwhile, in a state in which a specific button in the remote control device 200 is being pressed, recognition of up, down, left, or right movements may be excluded. That is, when the remote control device 200 moves away from or close to the display unit 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

FIG. 4B is an internal block diagram of the remote control device of FIG. 2.

Referring to the drawing, the remote control device 200 may include a wireless communication unit 420, a user input unit 430, a sensor unit 440, an output unit 450, a power supply unit 460, a storage unit 470, ad a control unit 480.

The wireless communication unit 420 may transmit and receive signals to and from any one of the display devices according to the embodiments of the present disclosure described above. Among the display devices according to embodiments of the present disclosure, one display device 100 will be described as an example.

In the present embodiment, the remote control device 200 may include an RF module 421 capable of transmitting and receiving signals to and from the display device 100 according to the RF communication standard. In addition, the remote control device 200 may include an IR module 423 capable of transmitting and receiving signals to and from the display device 100 according to the IR communication standard.

In the present embodiment, the remote control device 200 transmits a signal containing information on the movement of the remote control device 200 to the display device 100 through the RF module 421.

Also, the remote control device 200 may receive a signal transmitted by the display device 100 through the RF module 421. In addition, the remote control device 200 may transmit a command regarding power on/off, channel change, volume adjustment, or the like to the display device 100 through the IR module 423 as necessary.

The user input unit 430 may include a keypad, a button, a touch pad, or a touch screen. The user may input a command related to the display device 100 to the remote control device 200 by operating the user input unit 430. When the user input unit 430 includes a hard key button, the user may input a command related to the display device 100 to the remote control device 200 through a push operation of the hard key button. When the user input unit 430 includes a touch screen, the user may input a command related to the display device 100 to the remote control device 200 by touching a soft key of the touch screen. In addition, the user input unit 430 may include various types of input means that may be operated by a user, such as a scroll key or a jog key, and the present embodiment does not limit the scope of the present disclosure.

The sensor unit 440 may include a gyro sensor 441 or an acceleration sensor 443. The gyro sensor 441 may sense information on the movement of the remote control device 200.

For example, the gyro sensor 441 may sense information on the operation of the remote control device 200 based on the x, y, and z axes. The acceleration sensor 443 may sense information on the movement speed of the remote control device 200 and the like. Meanwhile, a distance measurement sensor may be further provided, whereby a distance to the display unit 180 may be sensed.

The output unit 450 may output a video or audio signal corresponding to the operation of the user input unit 430 or a signal transmitted from the display device 100. The user may recognize whether the user input unit 430 is operated or whether the display device 100 is controlled through the output unit 450.

For example, the output unit 450 may include an LED module 451 that emits light, a vibration module 453 that generates vibration, a sound output module 455 that outputs sound, or a display module 457 that outputs a video when the user input unit 430 is operated or a signal is transmitted and received through the wireless communication unit 420.

The power supply unit 460 supplies power to the remote control device 200. The power supply unit 460 may reduce power consumption by stopping power supply when the remote control device 200 has not moved for a predetermined time. The power supply unit 460 may restart power supply when a predetermined key provided in the remote control device 200 is operated.

The storage unit 470 may store various types of programs and application data required for control or operation of the remote control device 200. When the remote control device 200 transmits and receives signals wirelessly through the display device 100 and the RF module 421, the remote control device 200 and the display device 100 transmit and receive signals through a predetermined frequency band. The control unit 480 of the remote control device 200 may store and refer to information on a frequency band capable of wirelessly transmitting and receiving signals to and from the display device 100 paired with the remote control device 200 in the storage unit 470.

The control unit 480 may control all matters related to the control of the remote control device 200. The control unit 480 may transmit a signal corresponding to a predetermined key operation of the user input unit 430 or a signal corresponding to the movement of the remote control device 200 sensed by the sensor unit 440 through the wireless communication unit 420.

The user input interface unit 150 of the display device 100 may include a wireless communication unit 411 capable of wirelessly transmitting and receiving signals to and from the remote control device 200, and a coordinate value calculating unit 415 capable of calculating coordinate values of a pointer corresponding to the operation of the remote control device 200.

The user input interface unit 150 may transmit and receive signals wirelessly to and from the remote control device 200 through the RF module 412. In addition, signals transmitted by the remote control device 200 according to the IR communication standard may be received through the IR module 413.

The coordinate value calculating unit 415 may correct a hand shake or an error based on a signal corresponding to the operation of the remote control device 200 received through the wireless communication unit 411, and calculate the coordinate values (x, y) of the pointer 205 to be displayed on the display unit 180.

The transmission signal of the remote control device 200 input to the display device 100 through the user input interface unit 150 may be transmitted to the control unit 170 of the display device 100. The control unit 170 may determine information on the operation and key operation of the remote control device 200 based on the signal transmitted by the remote control device 200, and control the display device 100 in response thereto.

As another example, the remote control device 200 may calculate pointer coordinate values corresponding to the operation and output the same to the user input interface unit 150 of the display device 100. In this case, the user input interface unit 150 of the display device 100 may transmit information on the received pointer coordinate values to the control unit 170 without a separate process of correcting a hand shake or error.

In addition, as another example, the coordinate value calculating unit 415 may be provided in the control unit 170 instead of the user input interface unit 150 unlike the drawing.

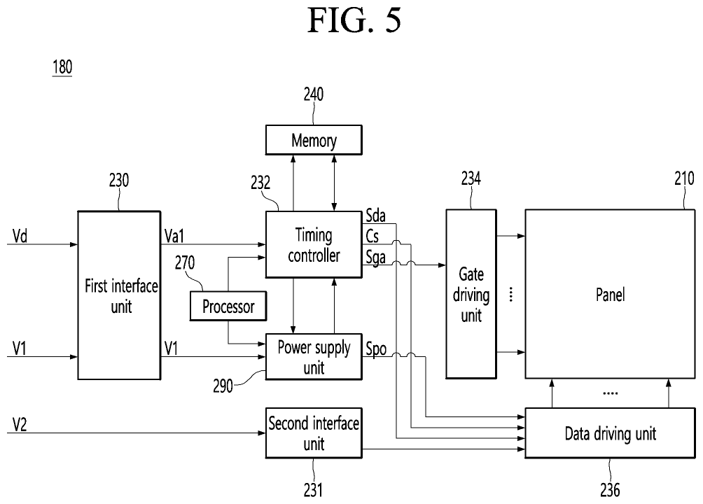

FIG. 5 is an internal block diagram of the display unit of FIG. 2.

Referring to the drawing, the display unit 180 based on an organic light emitting panel may include a panel 210, a first interface unit 230, a second interface unit 231, a timing controller 232, a gate driving unit 234, a data driving unit 236, a memory 240, a processor 270, a power supply unit 290, and the like.

The display unit 180 may receive a video signal Vd, first DC power V1, and second DC power V2, and display a predetermined video based on the video signal Vd.

Meanwhile, the first interface unit 230 in the display unit 180 may receive the video signal Vd and the first DC power V1 from the control unit 170.

Here, the first DC power supply V1 may be used for the operation of the power supply unit 290 and the timing controller 232 in the display unit 180.

Next, the second interface unit 231 may receive the second DC power V2 from the external power supply unit 190. Meanwhile, the second DC power V2 may be input to the data driving unit 236 in the display unit 180.

The timing controller 232 may output a data driving signal Sda and a gate driving signal Sga based on the video signal Vd.

For example, when the first interface unit 230 converts the input video signal Vd and outputs the converted video signal val, the timing controller 232 may output the data driving signal Sda and the gate driving signal Sga based on the converted video signal val.

The timing controller 232 may further receive a control signal, a vertical synchronization signal Vsync, and the like, in addition to the video signal Vd from the control unit 170.

In addition, the timing controller 232 may output the gate driving signal Sga for the operation of the gate driving unit 234 and the data driving signal Sda for operation of the data driving unit 236 based on a control signal, the vertical synchronization signal Vsync, and the like, in addition to the video signal Vd.

In this case, the data driving signal Sda may be a data driving signal for driving of RGBW subpixels when the panel 210 includes the RGBW subpixels.

Meanwhile, the timing controller 232 may further output the control signal Cs to the gate driving unit 234.

The gate driving unit 234 and the data driving unit 236 may supply a scan signal and the video signal to the panel 210 through a gate line GL and a data line DL, respectively, according to the gate driving signal Sga and the data driving signal Sda from the timing controller 232. Accordingly, the panel 210 may display a predetermined video.

Meanwhile, the panel 210 may include an organic light emitting layer and may be arranged such that a plurality of gate lines GL intersect a plurality of data lines DL in a matrix form in each pixel corresponding to the organic light emitting layer to display a video.

Meanwhile, the data driving unit 236 may output a data signal to the panel 210 based on the second DC power supply V2 from the second interface unit 231.

The power supply unit 290 may supply various levels of power to the gate driving unit 234, the data driving unit 236, the timing controller 232, and the like.

The processor 270 may perform various control of the display unit 180. For example, the gate driving unit 234, the data driving unit 236, the timing controller 232 or the like may be controlled.

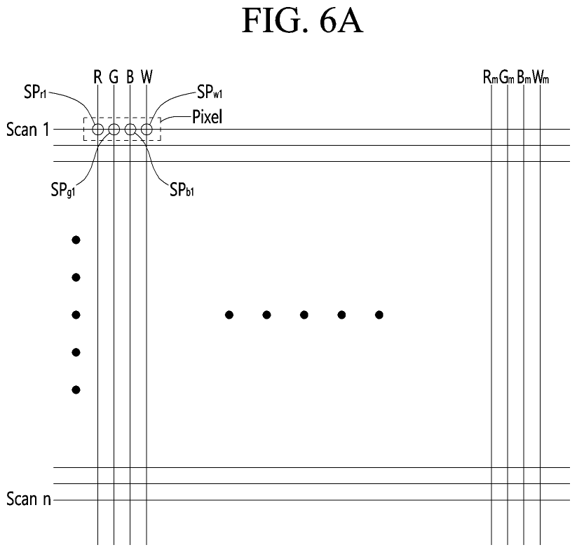

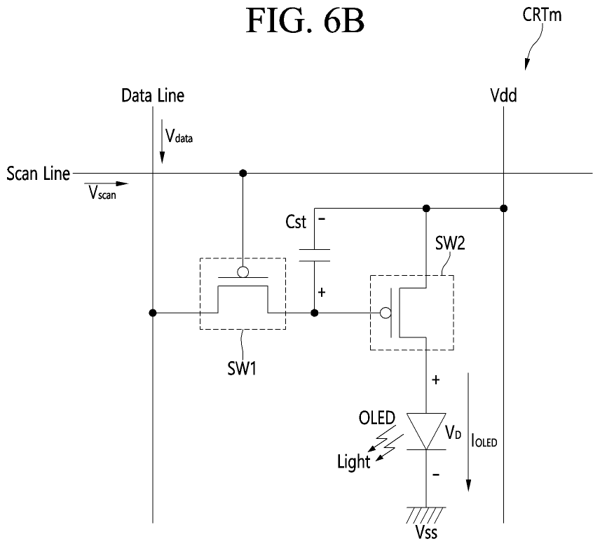

FIGS. 6A to 6B are views referred to for description of the organic light emitting panel of FIG. 5.

First, FIG. 6A is a diagram showing a pixel in the panel 210. The panel 210 may be an organic light emitting panel.

Referring to the drawing, the panel 210 may include a plurality of scan lines (Scan 1 to Scan n) and a plurality of data lines (R1, G1, B1, W1 to Rm, Gm, Bm and Wm) intersecting the scan lines.

Meanwhile, a pixel is defined at an intersection region of the scan lines and the data lines in the panel 210. In the drawing, a pixel having RGBW sub-pixels SPr1, SPg1, SPb1, and SPw1 is shown.

In FIG. 6A, although it is illustrated that the RGBW sub-pixels are provided in one pixel, RGB subpixels may be provided in one pixel. That is, it is not limited to the element arrangement method of a pixel.

FIG. 6B illustrates a circuit of a sub pixel in a pixel of the organic light emitting panel of FIG. 6A.

Referring to the drawing, an organic light emitting sub-pixel circuit CRTm may include a scan switching element SW1, a storage capacitor Cst, a driving switching element SW2, and an organic light emitting layer OLED, as active elements.

The scan switching element SW1 may be connected to a scan line at a gate terminal and may be turned on according to a scan signal Vscan, which is input. When the scan switching element SW1 is turned on, the input data signal Vdata may be transferred to the gate terminal of the driving switching element SW2 or one terminal of the storage capacitor Cst.

The storage capacitor Cst may be formed between the gate terminal and the source terminal of the driving switching element SW2, and store a predetermined difference between the level of a data signal transmitted to one terminal of the storage capacitor Cst and the level of the DC power Vdd transferred to the other terminal of the storage capacitor Cst.

For example, when the data signals have different levels according to a Pluse Amplitude Modulation (PAM) method, the level of power stored in the storage capacitor Cst may vary according to a difference in the level of the data signal Vdata.

As another example, when the data signals have different pulse widths according to the Pluse Width Modulation (PWM) method, the level of the power stored in the storage capacitor Cst may vary according to a difference in the pulse width of the data signal Vdata.

The driving switching element SW2 may be turned on according to the level of the power stored in the storage capacitor Cst. When the driving switching element SW2 is turned on, a driving current IOLED, which is proportional to the level of the stored power, flows through the organic light emitting layer OLED. Accordingly, the organic light emitting layer OLED may perform a light emitting operation.

The organic light emitting layer (OLED) includes a light emitting layer (EML) of RGBW corresponding to a subpixel, and may include at least one of a hole injection layer (HIL), a hole transport layer (HTL), an electron transport layer (ETL), and an electron injection layer (EIL) and may further include a hole blocking layer.

On the other hand, the sub pixels may emit white light in the organic light emitting layer (OLED) but, in the case of green, red, blue sub-pixels, a separate color filter is provided for realization of color. That is, in the case of green, red, and blue subpixels, green, red, and blue color filters are further provided, respectively. Meanwhile, since a white sub-pixel emits white light, a separate color filter is unnecessary.

On the other hand, although p-type MOSFETs are illustrated as the scan switching element SW1 and the driving switching element SW2 in the drawing, n-type MOSFETs or other switching elements such as JFETs, IGBTs, or SICs may be used.

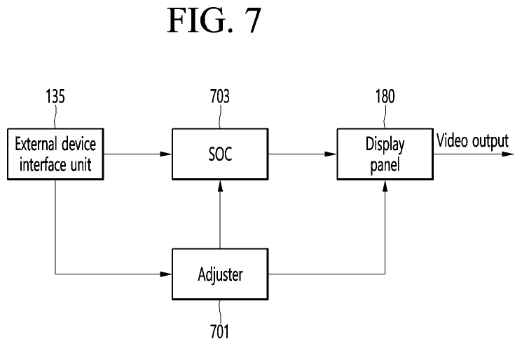

FIG. 7 is a diagram for describing a process of outputting a video by adjusting an output frequency according to an input frequency of a video signal.

An input frequency or output frequency to be described below may refer to a scan rate of a video.

The input frequency may be a driving frequency of a video signal input through the external device interface unit 135.

The output frequency may represent the driving frequency of the video signal when the display panel 180 outputs the video signal.

It is assumed that the video output frequency of the display panel 180 is set to a first output frequency. The first output frequency may be 120 Hz.

The external device interface unit 135 may receive a video signal from an external device connected to the display device 100.

The adjuster 701 may detect the input frequency of the video signal input through the external device interface unit 135.

The external device interface unit 135 may include an HDMI terminal.

The adjuster 701 may determine whether the input frequency of the video signal is equal to the second output frequency. The second output frequency may be 60 Hz.

The adjuster 701 may transmit a control signal for adjusting the output frequency of the video signal to the second output frequency when the input frequency of the input video signal is equal to the second output frequency.

Accordingly, the output frequency of the display panel 180 may be changed from the first output frequency to a second output frequency.

The adjuster 701 may transfer, to the display panel 180, a setting control signal for changing the setting for afterimage compensation of the display panel 180 from the first output frequency to the second output frequency when the input frequency of an input video signal is equal to the second output frequency.

A System On Chip (SOC) 703 may convert a video signal of a first format, which is input through the external device interface unit 135 into a video signal of the second format.

The first format may be an HDMI format, and the second format may be a Vx1 (V-by-one) format.

The SOC 703 may be referred to as a main board.

The SOC 703 may convert the video signal of the first format into the video signal of the second format.

The SOC 703 may bypass the video signal of the second format to the display panel 180. When the input frequency of the video signal is equal to the second output frequency, the SOC 703 may convert the video signal of the first format only to the video signal of the second format, and transfer the converted video signal of the second format to the display panel 180.

That is, when the input frequency of the video signal is equal to the second output frequency, the SOC 703 may convert only the format of the video signal and not compress the video signal.

The adjuster 701 and the SOC 703 may be components included in the control unit 170.

The display panel 180 may be another name of the display unit 180 of FIG. 1.

The display panel 180 may be the panel 210 of FIG. 5.

The display panel 180 may receive the video signal of the second format from the SOC 703.

Specifically, the display panel 180 may receive the video signal of the second format having a specific output frequency from the SOC 703.

The display panel 180 may change a frequency for afterimage compensation to an output frequency included in a setting control signal according to the setting control signal received from the adjuster 701.

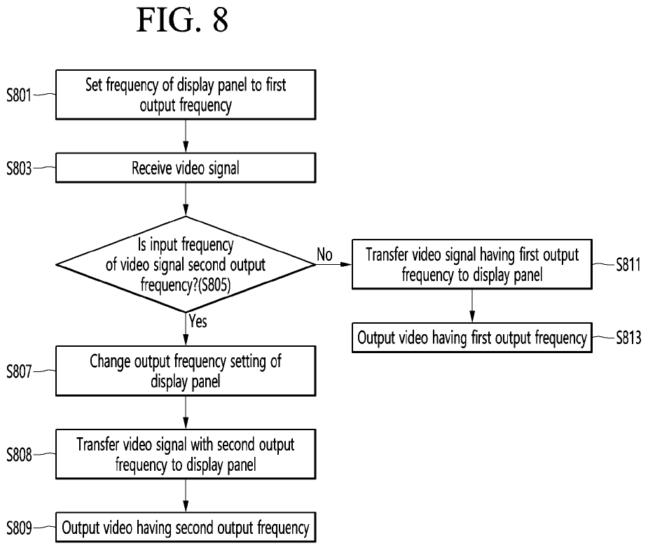

FIG. 8 is a flowchart for describing an operation method of a display device according to an embodiment of the present disclosure.

Hereinafter, an operation method of the display device 100 will be described in connection with the embodiment of FIG. 7.

The control unit 170 of the display device 100 may set the frequency for video output of the display panel 180 to the first output frequency (S801).

The first output frequency may be 120 Hz or 100 Hz.

The control unit 170 of the display device 100 may receive a video signal through the external device interface unit 135 (S803).

The external device interface unit 135 may include a high definition multimedia interface (HDMI) terminal.

The external device interface unit 135 may receive a video signal through an external device connected through the HDMI terminal.

The control unit 170 of the display device 100 may determine whether the input frequency of a received video signal is identical to a second output frequency (S805).

The video signal may have a preset input frequency.

The input frequency may represent the number of image frames input per second through the external device interface unit 135.

The adjuster 701 included in the control unit 170 may include a scan rate meter or a frequency meter capable of measuring an input frequency.

The adjuster 701 included in the control unit 170 may determine whether an input frequency of the video signal is equal to the second output frequency different from the first output frequency set to the output frequency of the display panel 180.

The second output frequency may be 60 Hz or 50 Hz.

When the input frequency of the video signal is equal to the second output frequency, the control unit 170 of the display device 100 may change the frequency setting of the display panel 180 to correspond to the second output frequency (S807).

The adjuster 701 included in the control unit 170 may transfer a control signal for changing the output frequency of the display panel 180 to the second output frequency to the display panel 180 when the input frequency of the video signal is equal to the second output frequency.

The display panel 180 may change the output frequency of the display panel 180 from the first output frequency to the second output frequency according to a control signal received from the adjuster 701.

The adjuster 701 may change an afterimage compensation sequence of the display panel 180 based on the second output frequency according to the control signal.

That is, the adjuster 701 may change a first afterimage compensation sequence performed based on the first output frequency of the display panel 180 to a second afterimage compensation sequence performed based on the second output frequency according to the control signal.

According to another embodiment of the present disclosure, when an operation mode of the display panel 180 is set to a game play mode, step 5805 or step 5807 may be performed.

The operation mode of the display panel 180 may include a still image playback mode, a moving image playback mode, and a game playback mode.

In the game play mode, a response speed of the video output according to a user input needs to be large. To this end, in the game play mode, as the input-lag time decreases, it may be more benefit for the game play of the user.

The control unit 170 of the display device 100 may transfer a video signal with a second output frequency to the display panel 180 (S808).

The SOC 703 included in the control unit 170 may convert a first type of video signal received from the external device interface unit 135 into a second type of video signal.

The SOC 703 may convert an HDMI type video signal into a V-by-one type of video signal when the external device interface unit 135 includes an HDMI terminal, and transfer the V-by-one type of video signal to the display panel 180.

The V-by-one type video signal may have a second output frequency equal to an input frequency.

That is, the SOC 703 may change only a data format without changing the frequency of a second type of video signal. The SOC 703 may bypass the second type of video signal to the display panel 180.

The control unit 170 of the display device 100 may output a video having the second output frequency through the display panel 180 (S809).

Meanwhile, when the input frequency of the video signal is not equal to the second output frequency and is equal to the first output frequency, the control unit 170 of the display device 100 may transfer the video signal having the first output frequency to the display panel 180 (S811).

The SOC 703 of the control unit 170 may convert the first type of video signal having the first output frequency into the second type of video signal. The first type may be an HDMI type, and the second type may be a V-by-one type.

The control unit 170 of the display device 100 may output a video having the first output frequency through the display panel 180 (S813).

That is, when the output frequency of the display panel 180 is set to the first output frequency and the input frequency of a video signal input through the external device interface unit 135 is equal to the first output frequency, the control unit 170 may not change settings of the display panel 180.

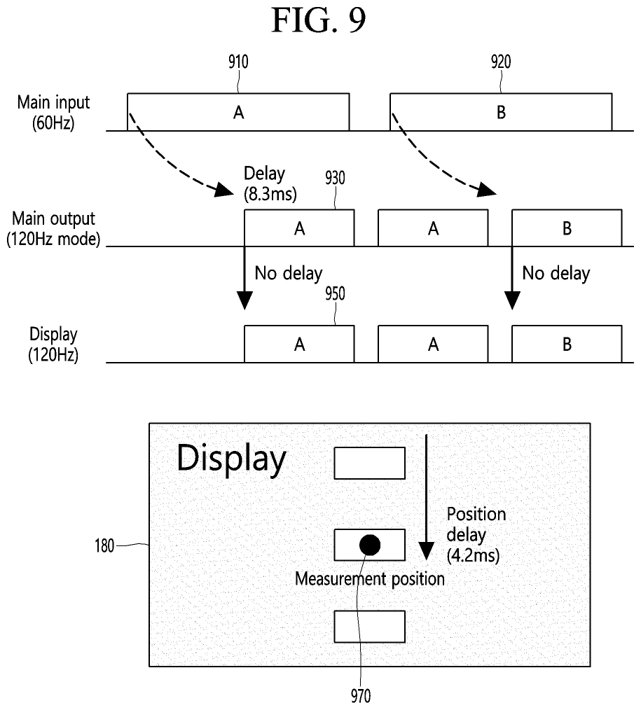

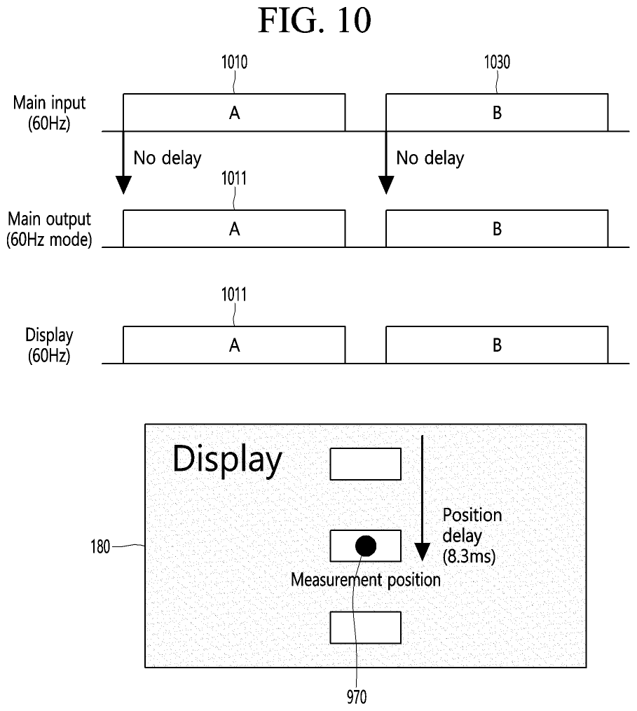

FIGS. 9 and 10 are diagrams shoving comparison with the prior art to show that input-lag is improved according to the present disclosure.

FIG. 9 is a diagram for describing a process of measuring an input-lag time according to the prior art.

In FIG. 9, it is assumed that the input frequency of the video signal is 60 Hz, and the output frequency of the display panel 180 is set to 120 Hz. According to the prior art, the output frequency of the display panel 180 is designed not to be changed.

Referring to FIG. 9, a first data region 910 and a second data region 920 of a video signal corresponding to 60 Hz are illustrated.

It is assumed that a time interval of each of the first data region 910 and the second data region 920 is approximately 16.6 ms. Since the input frequency is 60 Hz, the input frequency may be obtained through a calculation process of 1 (s)/60 (Hz).

The first data region 910 may be a region containing data for 60 image frames scanned for one second.

A blank region may exist between the first data region 910 and the second data region 920.

When the input frequency of the video signal is 60 Hz and the output frequency of the display panel 180 is 120 Hz, the display device may wait until 60 image frames are further input. In this process, a delay occurs by a time corresponding to 1/2 of the time interval of the first data region 910 (8.3 ms).

The delay is a delay caused because it is necessary to wait until 120 image frames are input when an output frequency of the display panel 180 is 120 Hz because 60 image frames need to be input per second when the input frequency is 60 Hz.

After the elapse of 8.3 ms, the display device may compress the first data region 910 to generate a first compressed data region 930.

A time interval of the first compressed data region 930 is 8.3 ms, which is the half of the time interval of the first data region 910.

The display device may convert the first compressed data region 930 of the HDMI type to the first compressed data region 950 of the V-by-one type. During the data conversion process, a delay of 0.8 ms may occur.

The display panel 180 may output the first compressed data region 950 of the v-by-one type according to an output frequency of 120 Hz.

The display device may measure a time at which a video signal is displayed at a central point 970 of the display panel 180 to measure an input-lag time.

The rectangular region including the central point 970 may flicker periodically, and the remaining region except the rectangular region may be displayed in black.

Since the time interval of the first compressed data region 950 of the V-by-one type is 8.3 ms, the time at which the video signal is output onto the central point 970 of the display panel 180 may be 4.2 ms which is approximately half of 8.3 ms. Since the time required to entirely display a video corresponding to the first compressed data region 950 of the V-by-one type on the display panel 180 is 8.3 ms, the video may be displayed at the time when approximately 4.2 ms which is half of 8.3 ms has elapsed.

Accordingly, according to the prior art, when the input frequency is 60 Hz and the output frequency of the display panel 180 is 120 Hz, the input-lag time may be calculated as 8.3+0.8+4.2=13.3 ms.

Next, according to an embodiment of the present disclosure, a process for measuring an input-lag is described.

In FIG. 10, it is assumed that the input frequency of a video signal is 60 Hz, and an output frequency of the display panel 180 is changed from 120 Hz to 60 Hz according to the detection of the input frequency.

That is, when the input frequency of the video signal is 60 Hz, the control unit 170 of the display device 100 may change the output frequency of the display panel 180 from 120 Hz to 60 Hz. The process of adjusting the output frequency of the display panel 180 is as described with reference to FIGS. 7 and 8.

Referring to FIG. 10, a first data region 1010 and a second data region 1030 corresponding to a video signal of 60 Hz are illustrated. A blank region may exist between the first data region 1010 and the second data region 1030.

The time interval of the first data region 1010 may be obtained by 1 (s)/60 (Hz)=16.6 (ms).

The SOC 703 of the control unit 170 may bypass the first data region 1010 to the display panel 180 without compressing the first data region 1010.

More specifically, the SOC 703 may convert the first data region 1010 of the HDMI-type into a data region 1011 of the V-by-one type, and the converted data region 1011 of the V-by-one type may be transferred to the display panel 180. In the data conversion process, a delay of 1 ms occurs.

The display panel 180 may output the converted data region 1011 of the V-by-one type according to an output frequency of 60 Hz.

The display device 100 may measure a time at which a video signal is displayed at the central point 970 of the display panel 180 in order to measure the input-lag time.

The rectangular region including the central point 970 may flicker periodically, and the remaining region except the rectangular region may be displayed in black.

Since the time interval of the data region 1011 of the V-by-one type is 16.6 ms, the time when the video signal is output at the central point 970 of the display panel 180 is 8.3 ms, which is half of 16.6 ms.

Since the time required to entirely display a video corresponding to the data region 1011 of the V-by-one type on the display panel 180 is 16.6 ms, the video may be displayed at the time when approximately 8.3 ms which is half of 16.6 ms has elapsed.

The input-lag time according to an embodiment of the present disclosure is 9.3 (ms) (1+8.3), which is the sum of 1 ms caused in the data conversion process and 8.3 ms, which is the time taken to output the video to the display panel 180.

As described above, according to an embodiment of the present disclosure, since the output frequency of the display panel 180 is changed according to the input frequency of the video signal, the process of compressing the video signal is unnecessary, thus reducing the input-lag time.

Accordingly, a user watching the video may feel the output delay of the video relatively less.

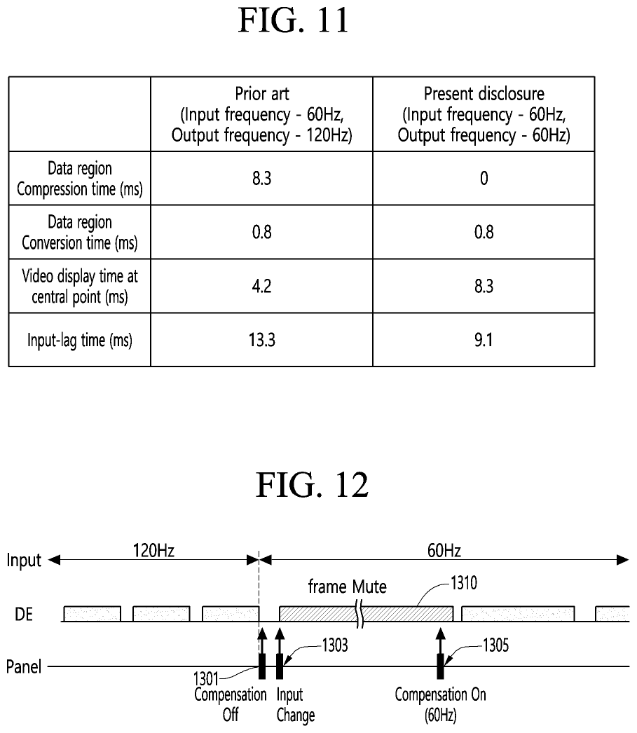

FIG. 11 is a diagram for describing a table in which input-lag times of the prior art and the present disclosure are compared with each other.

FIG. 11 is a table summarizing input-lag times for FIGS. 9 and 10.

According to the prior art, the data processing delay time of a data region is 8.3 ms, and according to an embodiment of the present disclosure, the data processing delay time of the data region is 0 ms.

According to an embodiment of the present disclosure, since the output frequency of the display panel 180 is adjusted according to the input frequency of the video signal, a delay time does not occur.

A conversion time required to convert an HDMI-type of data region into a V-by-one type of data region is 0.8 ms according to the prior art.

Similarly, a conversion time required to an HDMI-type of data region into a V-by-one type of data region is 0.8 ms according to an embodiment of the present disclosure.

According to the prior art, the time required to display a video at a central point of the display panel 180 is 4.2 ms, and according to an embodiment of the present disclosure, the time required to display a video at a central point of the display panel 180 is 8.3 ms.

Consequently, according to the prior art, the input-lag delay time is 8.3+0.8+4.2=13.3 (ms), and according to an embodiment of the present disclosure, the input lag delay time is 0+1+8.3=9.3 (ms).

As described above, according to an embodiment of the present disclosure, as an output frequency is adjusted according to an input frequency of a video signal, input lag time may be greatly reduced.

FIG. 12 is a diagram showing an example of changing a compensation sequence for afterimage compensation when an output frequency of a display panel is changed according to an input frequency according to an embodiment of the present disclosure.

The compensation sequence may represent a sequence for compensating for afterimages according to the output frequency of the display panel 180.

In FIG. 12, DE stands for Data Enablement, and may represent a data region.

When the input frequency of the video signal is 120 Hz, the display device 100 may turn on a first compensation sequence suitable for 120 Hz.

The display device 100 may turn off the first compensation sequence based on 120 Hz at a first time point 1301 at which a video signal of 60 Hz is input.

Thereafter, the display device 100 may change the output frequency of the display panel 180 from 120 Hz to 60 Hz at a second time point 1303. p The display device 100 may turn on the second compensation sequence based on 60 Hz from a third time point 1305 at which a predetermined time has elapsed from the second time point 1303. Here, the predetermined time may be a time required for buffering necessary to change the compensation sequence.

During the predetermined time, the data region may be muted (frame Mute).

As described above, according to an embodiment of the present disclosure, an output frequency of the display panel 180 may be changed according to an input frequency, and a compensation sequence may be set according to the changed output frequency.

According to an embodiment of the present disclosure, the above-described method may be implemented with codes readable by a processor on a medium in which a program is recorded. Examples of the medium readable by the processor include a ROM (Read Only Memory), a Random Access Memory (RAM), a CD-ROM, a magnetic tape, a floppy disk, an optical data storage device, and the like, and may be implemented in the form of a carrier wave (for example, transmission through the Internet).

The display device described above is not limited to the configuration and method of the above-described embodiments, and the above embodiments may be configured by selectively combining all or some of embodiments such that various modifications may be made.

What is claimed is:

1. A display device comprising:
a display panel configured to be driven with a first output frequency or a second output frequency;
an external interface configured to receive a video signal; and
at least one controller configured to:
change an output frequency of the display panel from the first output frequency to the second output frequency when an input frequency of the video signal received through the external interface is detected at the second output frequency in a state in which the output frequency of the display panel is set to the first output frequency.

2. The display device of claim 1, wherein the at least one controller is further configured to change a compensation sequence for afterimage compensation of the display panel according to the second output frequency to which the output frequency of the display panel is changed.

3. The display device of claim 2, wherein the compensation sequence is a first compensation sequence to be performed based on the first output frequency when the output frequency of the display panel is set to the first output frequency, and
wherein the at least one controller is further configured to turn off the first compensation sequence and turn on a second compensation sequence to be performed based on the second output frequency.

4. The display device of claim 1, wherein the video signal is of a first type, and
wherein the at least one controller is further configured to convert the video signal of the first type into a video signal of a second type and transfer the converted video signal of the second type to the display panel.

5. The display device of claim 4, wherein the at least one controller is further configured to transfer the video signal of the second type to the display panel without compression of the video signal of the second type.

6. The display device of claim 5, wherein the first type is an HDMI type, and the second type is a V-by-one type.

7. The display device of claim 1, wherein the at least one controller includes:
an adjuster configured to detect the input frequency of the video signal and transfer a control signal for changing setting of the output frequency of the display panel to the display panel; and
a System on Chip (SoC) configured to convert the video signal to a video signal of a type capable of being output by the display panel and transfer the converted video signal to the display panel.

8. The display device of claim 1, wherein each of a plurality of pixels constituting the display panel includes an organic light emitting diode (OLED).

9. The display device of claim 1, wherein the first output frequency is equal to about 120 Hz or 100 Hz, and
wherein the second output frequency is equal to about 60 Hz or 50 Hz.

10. The display device of claim 1, wherein an operation mode of the display panel is capable of being set to one of a still image playback mode, a moving image playback mode or a game mode,
wherein the at least one controller is further configured to detect the input frequency of the video signal when the operation mode of the display panel is set to the game mode.

11. A method for operating a display device, the method comprising:
receiving a video signal; and
changing an output frequency of a display panel of the display device from a first output frequency to a second output frequency when an input frequency of the received video signal is detected at the second output frequency in a state in which the output frequency of the display panel is set to the first output frequency.

12. The method of claim 11, further comprising:
changing a compensation sequence for afterimage compensation of the display panel according to the second output frequency to which the output frequency of the display panel is changed.

13. The method of claim 12, wherein the compensation sequence is a first compensation sequence to be performed based on the first output frequency when the output frequency of the display panel is set to the first output frequency, and
wherein changing the compensation sequence includes turning off the first compensation sequence and turning on a second compensation sequence to be performed based on the second output frequency.

14. The method of claim 11, wherein the video signal is of a first type, and
wherein the method further comprises:
converting the video signal of the first type into a video signal of a second type; and
transferring the converted video signal of the second type to the display panel.

15. The method of claim 14, further comprising:
transferring the video signal of the second type to the display panel without compression of the video signal of the second type.

16. The method of claim 15, wherein the first type is an HDMI type, and the second type is a V-by-one type.

17. The method of claim 11, further comprising:
detecting the input frequency of the video signal;
transferring a control signal for changing setting of the output frequency of the display panel to the display panel; and
converting the video signal to a video signal of a type capable of being output by the display panel; and
transferring the converted video signal to the display panel.

18. The method of claim 11, wherein each of a plurality of pixels constituting the display panel includes an organic light emitting diode (OLED).

19. The method of claim 11, wherein the first output frequency is equal to about 120 Hz or 100 Hz, and
wherein the second output frequency is equal to about 60 Hz or 50 Hz.

20. The method of claim 11, wherein an operation mode of the display panel is capable of being set to one of a still image playback mode, a moving image playback mode or a game mode,
wherein the method further comprises:
detecting the input frequency of the video signal when the operation mode of the display panel is set to the game mode.
